(19) United States
(12) Patent Application Publication
(10) Pub. No.: US 2024/0143795 A1
(43) Pub. Date: May 2, 2024

(54) METHOD AND DEVICE FOR INTERSECTING UNBALANCED PRIVATE SETS

(71) Applicant: Alipay (Hangzhou) Information Technology Co., Ltd., Hangzhou (CN)

(72) Inventor: Qixian ZHOU, Hangzhou (CN)

(21) Appl. No.: 18/495,667

(22) Filed: Oct. 26, 2023

(30) Foreign Application Priority Data
Oct. 28, 2022 (CN) 202211339294.1

(51) Int. Cl. G06F 21/60; G06F 21/62

(52) U.S. Cl. CPC G06F 21/602; G06F 21/6227; G06F 21/6245

(57) ABSTRACT

The present application provides a method for unbalanced PSI. A first party holds a first data set, a second party holds a second data set, and the method includes: performing data preprocessing on private data in the first data set to obtain a first mapped data set; obtaining a function in a polynomial form through fitting based on the first mapped data set; combining coefficients of all terms in the function into a coefficient vector; receiving a public key from the second party, and performing homomorphic encryption on the coefficient vector by using the public key to obtain an encrypted coefficient vector; receiving a ciphertext input vector from the second party, and obtaining a ciphertext result through computation with reference to the encrypted coefficient vector; and sending the ciphertext result to the second party, so that the second party obtains a result of unbalanced PSI. Correspondingly, the present invention discloses an apparatus for unbalanced PSI.

### TECHNICAL FIELD

The present application relates to the field of computer application and information technologies, and in particular, to a method and an apparatus for unbalanced PSI, a computer-readable storage medium, and an electronic device.

### BACKGROUND

With the enactment and improvement of laws and regulations such as Cybersecurity Law and Personal Information Protection Law, data compliance and privacy security increasingly attract more attention. Emerging privacy computing technologies provide key support for data privacy security and for being available and unrecognizable. PSI is a very important algorithm in current privacy computing, and has been applied in a large scale in a plurality of scenarios such as government affairs, finance, and medical care. PSI (private set intersection) can also be referred to as secure intersection, and is one of basic functions of secure multi-party computation (SMPC or MPC for short). When participating parties hold their own private data sets (that is, private sets), PSI can enable any party to obtain an intersection of the private data sets of the other parties while protecting data privacy of each party.

Most of current private data set intersection technologies are in a balanced scenario, that is, amounts of data held by participants are approximately equal. In an unbalanced scenario, that is, when a difference between amounts of data held by participants is large, a related private data set intersection technology is still being developed and needs improvement. In the existing technologies, some solutions implement secure PSI in an unbalanced scenario by using a fully homomorphic encryption technology. The existing solutions have problems such as low ciphertext computing efficiency, large ciphertext size, and complex implementation.

### SUMMARY

The present application provides a method and an apparatus for unbalanced PSI, a computer-readable storage medium, and an electronic device, which improves ciphertext computing efficiency and compatibility.

According to an aspect of the present application, a method for unbalance PSI is provided. A first party holds a first data set, a second party holds a second data set, and the method is performed by the first party and includes: performing data preprocessing on private data in the first data set to obtain a first mapped data set; obtaining a function in a polynomial form through fitting based on the first mapped data set; combining coefficients of all terms in the function into a coefficient vector; receiving a public key from the second party, and performing homomorphic encryption on the coefficient vector by using the public key to obtain an encrypted coefficient vector; receiving a ciphertext input vector from the second party, and obtaining a ciphertext result through computation with reference to the encrypted coefficient vector; and sending the ciphertext result to the second party, so that the second party obtains a result of unbalanced PSI.

In an implementation, the performing data preprocessing on the first data set further includes: performing data preprocessing by using OPRF, where all data in the first mapped data set are pseudorandom numbers.

In an implementation, the private data of the first party is a user identifier of a to-be-queried user, and private data of the second party is a group of user identifiers of a target category.

In an implementation, the ciphertext input vector is obtained based on following steps: generating a random matrix; generating an identity matrix; generating an invertible matrix pair; and obtaining the ciphertext input vector through computation based on the random matrix, the identity matrix, the invertible matrix pair, and a private key of the second party.

In an implementation, the function is obtained through fitting by using a least squares method/procedure.

According to an aspect of the present application, a method for unbalance PSI is provided. A first party holds a first data set, a second party holds a second data set, and the method is performed by the second party and includes: performing data preprocessing on private data in the second data set to obtain a second mapped data set; generating a pair of a private key and a public key, and sending the public key to the first party; encrypting data in the second mapped data set based on the private key to generate a ciphertext input vector and a decryption key; sending the ciphertext input vector to the first party; and receiving a ciphertext result based on the ciphertext input vector from the first party, and decrypting the ciphertext result by using the decryption key to obtain a result of unbalanced PSI.

In an implementation, the preprocessing is performed by using OPRF, and all data in the second mapped data set are pseudorandom numbers.

In an implementation, the ciphertext input vector is obtained based on following steps: generating a random matrix; generating an identity matrix; generating an invertible matrix pair; and obtaining the ciphertext input vector through computation based on the private key, the random matrix, the identity matrix, and the invertible matrix pair.

In an implementation, the decryption key is generated based on following steps: generating a random matrix; generating an identity matrix; generating an invertible matrix pair; and generating the decryption key through computation based on the random matrix, the identity matrix, and the invertible matrix pair.

In an implementation, if the result of the unbalanced PSI obtained through the decrypting is 0, private data of the first party is intersection data; and if the result of the unbalanced PSI obtained through the decrypting is not 0, the private data of the first party is not the intersection data.

In an implementation, private data of the first party is a user identifier of a to-be-queried user, and the private data of the second party is a group of user identifiers of a target category.

According to an aspect of the present application, an apparatus for unbalanced PSI is provided. A first party holds a first data set, a second party holds a second data set, and the apparatus is disposed in the first party and includes: a preprocessing unit, configured to perform data preprocessing on private data in the first data set to obtain a first mapped data set; a fitting unit, configured to: obtain a function in a polynomial form through fitting based on the first mapped data set, and combine coefficients of all terms in the function into a coefficient vector; an encryption unit, configured to: receive a public key from the second party, and perform homomorphic encryption on the coefficient vector by using the public key to obtain an encrypted coefficient vector; a computation unit, configured to: receive a ciphertext input vector from the second party, and obtain a ciphertext result through computation with reference to the encrypted coefficient vector; and a sending unit, configured to send the ciphertext result to the second party, so that the second party obtains a result of unbalanced PSI.

In an implementation, the preprocessing unit performs data preprocessing by using OPRF, and all data in the first mapped data set are pseudorandom numbers.

In an implementation, the function is obtained through fitting by using a least squares method/procedure.

In an implementation, the private data of the first party is a user identifier of a to-be-queried user, and private data of the second party is a group of user identifiers of a target category.

According to an aspect of the present application, an apparatus for unbalanced PSI is provided. A first party holds a first data set, a second party holds a second data set, and the apparatus is disposed in the second party and includes: a preprocessing unit, configured to perform data preprocessing on private data in the second data set to obtain a second mapped data set; a key generation unit, configured to: generate a pair of a private key and a public key based on a homomorphic encryption algorithm, and send the public key to the first party; an encryption unit, configured to encrypt data in the second mapped data set based on the private key to generate a ciphertext input vector and a decryption key; a sending unit, configured to send the ciphertext input vector to the first party; and a decryption unit, configured to: receive a ciphertext result based on the ciphertext input vector from the first party, and decrypt the ciphertext result by using the decryption key to obtain a result of unbalanced PSI.

In an implementation, the preprocessing unit performs data preprocessing by using OPRF, and all data in the second mapped data set are pseudorandom numbers.

In an implementation, the encryption unit obtains the ciphertext input vector based on following steps: generating a random matrix; generating an identity matrix; generating an invertible matrix pair; and obtaining the ciphertext input vector through computation based on the private key, the random matrix, the identity matrix, and the invertible matrix pair.

In an implementation, the encryption unit generates the decryption key based on following steps: generating a random matrix; generating an identity matrix; generating an invertible matrix pair; and generating the decryption key through computation based on the random matrix, the identity matrix, and the invertible matrix pair.

In an implementation, if the result of the unbalanced PSI obtained through the decrypting is 0, it is determined that private data of the first party is intersection data; and if the result of the unbalanced PSI obtained through the decrypting is not 0, the private data of the first party is not the intersection data.

In an implementation, private data of the first party is a user identifier of a to-be-queried user, and the private data of the second party is a group of user identifiers of a target category.

According to an aspect of the present application, a computer-readable storage medium is provided. The computer-readable storage medium stores instructions, and when the instructions are run on a processor, the method for unbalanced PSI according to an aspect of the present application is performed.

According to an aspect of the present application, an electronic device is provided, including: one or more processors, and a memory. The memory stores one or more computer programs, and the one or more computer programs include instructions. When the instructions are executed by the processor, the processor is enabled to perform the method for unbalanced PSI according to an aspect of the present application. It can be appreciated from the above that, in the implementations of the present specification, the first party holding the first data set can obtain, from the second party holding the second data set, only the ciphertext input vector obtained through homomorphic encryption, and the first party cannot infer any data included in the second data set by using the ciphertext input vector. The first party sends the ciphertext result to the second party, and the ciphertext result is also obtained by the first party through linear transformation computation by using two encryption matrices. The second party decrypts the ciphertext result by using the decryption key, and can only determine, based on the decrypted ciphertext result, whether the private data of the first party belongs to the second data set, and cannot inversely deduce and determine a specific location of to-be-queried data in the data set, so that a security requirement of an anonymous query can be satisfied. Compared with the existing technologies, in the method for unbalanced PSI in this solution, a complex computation process of PSI is converted into a simple matrix transformation operation, which not only ensures ciphertext computing efficiency and retrieval efficiency, but also can implement many advantages such as batch processing and compatibility.

### BRIEF DESCRIPTION OF DRAWINGS

The example implementations of the present application can be further appreciated with reference to the accompanying drawings, to understand the aspects of the present application more clearly.

FIG. 1 is an example block diagram illustrating a procedure of a method for unbalanced PSI according to a first implementation of the present application;

FIG. 2 is an example block diagram illustrating a procedure of a method for unbalanced PSI according to a second implementation of the present application;

FIG. 3 is an example schematic diagram illustrating a system architecture of an apparatus for unbalanced PSI according to a third implementation of the present application;

FIG. 4 is an example schematic diagram illustrating a system architecture of an apparatus for unbalanced PSI according to a fourth implementation of the present application; and

FIG. 5 is an example diagram illustrating a structure of a computer-readable storage medium corresponding to a method for unbalanced PSI according to another implementation of the present application.

### DESCRIPTION OF EMBODIMENTS

To make the technical content disclosed in the present application more detailed and complete, references can be made to the accompanying drawings and the following example implementations of the present application. Same reference numerals in the accompanying drawings represent same or similar components. However, a person of ordinary skill in the art should understand that the implementations provided below are not intended to limit the scope covered by the present application. In addition, the accompanying drawings are merely used for example description, and are not drawn based on original sizes of the accompanying drawings.

The following further describes in detail example implementations of each aspect of the present application with reference to the accompanying drawings.

The term used in one or more implementations of the present specification is merely used for the purpose of describing a particular implementation and is not intended to limit one or more implementations of the present specification. The singular forms “a”, “the”, and “the” used in one or more implementations of the present specification and the appended claims are also intended to include most forms unless the context clearly represents other meanings. It should be further understood that the term “and/or” used in one or more implementations of the present specification refers to and includes any of or all possible combinations of one or more associated listed items. It should be understood that, although the terms such as “first” and “second” can be used in one or more implementations of the present specification to describe various types of information, the information should not be limited to these terms. These terms are merely used to distinguish information of a same type from each other. For example, without departing from the scope of one or more implementations of the present specification, “first” can be referred to as “second”, and similarly, “second” can be referred to as “first”. Depending on the context, the term “if” used herein can be used in an exchangeable manner with or be referred to as “when . . . ” or “during . . . ” or “in response to determining that . . . ”.

The flowchart is used in the present specification to describe the operations performed by the system according to the implementations of the present specification. It should be understood that previous or subsequent operations are not necessarily performed precisely in an order. Instead, the steps can be processed in a reverse order or simultaneously. In addition, other operations can be added to these processes, or one operation or several operations can be removed from these processes.

First, terms in the description of one or more implementations of the present application are explained.

Private set intersection: This is referred to as PSI for short. Assuming that entity A has identification information or IDs of a group of users and entity B has IDs of a group of users, an intersection of user IDs of the two entities can be identified by using PSI while data privacy is protected, and no information other than intersection data is disclosed. PSI is widely used in various scenarios such as finance, public affairs, and medical care, and is one of the most mature technologies in privacy computing.

Unbalanced PSI: It is assumed that a size of an ID data set of entity A is X and a size of an ID data set of entity B is Y. When X<<Y, PSI in this scenario is referred to as the unbalanced PSI. If the existing PSI technology is directly used, entity A with a smaller data amount requires a same amount of computation and same communication overheads as entity B with a larger data amount.

Homomorphic encryption: This is a public key encryption solution. An operation in a ciphertext domain obtained after decryption is equivalent to a corresponding operation in a plaintext domain.

Somewhat homomorphic encryption: This is a type of homomorphic encryption that supports both ciphertext addition and multiplication operations only with a limited multiplication depth.

Oblivious pseudorandom function: This is referred to as “OPRF” for short, and is a cryptographic protocol in which two participants Sender and Receiver exist, where the Sender provides a key k and a function F, and the Receiver provides an input x. When the cryptographic protocol is run, the Receiver obtains an output F(k, x), and the Sender has no output. In a protocol running process, the Sender does not know the input x, and the Receiver does not know the function F and the key k.

Private data: This includes but is not limited to personal information (a personal name, birthday, nation, nationality, a family relationship, an address, a personal telephone number, an email, etc.), personal identity information (an identity card, a military officer certificate, a passport, a driving license, an employee's card, an access card, a social security card, a residence permit, etc.), personal biometric recognition information (personal genes, fingerprints, voiceprints, eyeprints, palmprints, auricles, irises, facial features, etc.), network identity identification information (a system account number, an IP address, an email address, a password and a password protection answer related to the above, a user personal digital certificate, etc.), personal health and physiological information (related records generated due to illness and treatment of an individual, such as a disease, an inpatient medical record, a doctor's order, a test report, a surgery and anesthesia record, a nursing record, a medication administration record, drug and food allergy information, birth information, a past medical history, a diagnosis and treatment condition, a family medical history, a current medical history, and an infectious disease history, as well as generated information related to a personal body health status, a weight, a height, a vital capacity, etc.), personal education and work information (a personal occupation and position, a workplace, an academic qualification, an academic degree, education experience, work experience, a training record, a transcript, etc.), personal property information (e.g., a bank account number, authentication information (a password), transaction information (including a fund amount, payment and collection records, etc., real estate information, a credit record, credit information, transaction and consumption records, a flow record, etc., as well as virtual property information such as virtual currency, virtual transactions, and game redemption codes), personal communication information (communication records and content, text messages, multimedia messages, emails, and data (which is usually referred to as metadata) describing personal communication, etc.), contact information (an address book, a friend list, a group list, an email address list, etc.), personal Internet access records (refer to user operation records stored in logs, including website browsing records, software usage records, click records, etc.), personal frequently used device information (refers to information describing a basic status of a personal frequently used device, including a hardware serial number, a device MAC address, a software list, a unique device identification code (such as an IMEI/android ID/IDFA/OPENUDID/GUID, or IMSI information of a SIM card.), personal location information (including a track route, precise positioning information, accommodation information, latitude and longitude, etc.), and other information (a marriage history, beliefs, an undisclosed criminal record, etc.).

For homomorphic encryption, an operation in a ciphertext domain obtained after decryption is equivalent to a corresponding operation in a plaintext domain. In other words, corresponding computation, for example, an addition operation and a multiplication operation, can still be performed on encrypted data. Therefore, a value obtained after a ciphertext computing result is decrypted is equivalent to a computation result of corresponding plaintext data in plaintext. Generally, homomorphic encryption can be represented by using the following formula:

Enc(f(m₁, m₂))=f(Enc(m₁), Enc(m₂))

where m₁and m₂ represent plaintext data, Enc(m₁), and Enc(m₂) represent ciphertext data, and f represents an operation.

The formula indicates that performing an operation on the plaintext m₁ and m₂ after the plaintext is encrypted is equivalent to encrypting the plaintext m₁ and m₂ after an operation is performed on the plaintext. The above formula indicates a basic property of homomorphic encryption, that is, homomorphic encryption is homomorphic to an operation, and a computation result in the ciphertext domain obtained after decryption is equal to the computation result in the plaintext domain.

The present application also proposes, based on homomorphic encryption, a method for unbalanced PSI. A complex computation process of PSI is converted into a simple matrix transformation operation, which not only ensures ciphertext computing efficiency and retrieval efficiency, but also can implement many advantages such as batch processing and compatibility.

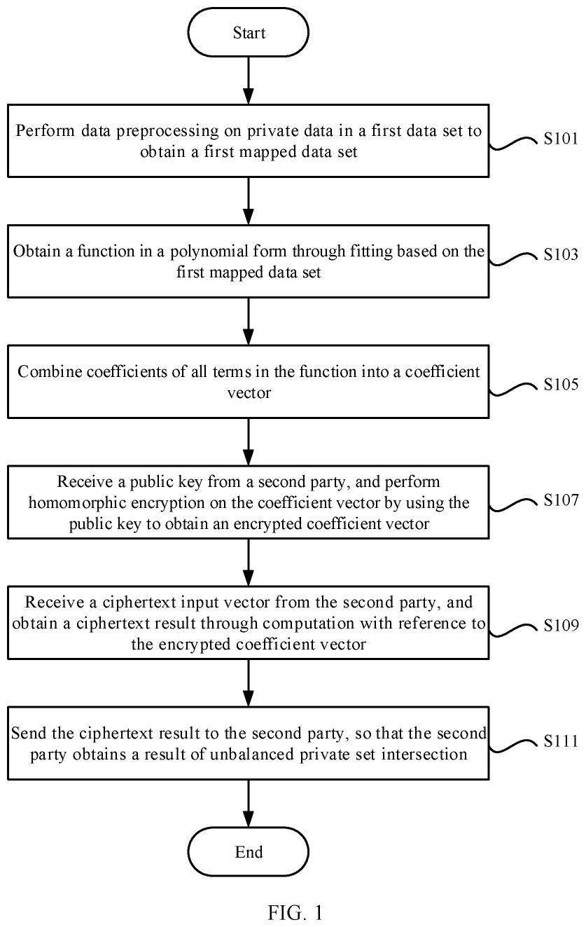

FIG. 1 is an example block diagram illustrating a procedure of a process for unbalanced PSI according to a first implementation of the present application. Referring to FIG. 1, in this implementation, a first party holds a first data set Y={y₀₁, yₐ₂, . . . myₒₙ}, a second party holds a second data set X={xₒ₁, . . . , xₒₘ}, and the process for unbalanced PSI is implemented by the first party holding the first data set. In the processes in this implementation, all ciphertext operations relate to only multiplication and addition, and therefore can be compatible with any somewhat homomorphic encryption solution.

As shown in FIG. 1, a process for unbalanced PSI includes following steps.

Step S101: Perform data preprocessing on private data in the first data set to obtain a first mapped data set.

In some implementations, the private data of the first party is a user identifier of a to-be-queried user, and private data of the second party is a group of user identifiers of a target category.

In some implementations, the private data in the first data set is preprocessed by using OPRF to covert the first data set into the first mapped data set, which improves security of an anonymous query. Correspondingly, the private data in the first data set is converted into pseudorandom numbers in the first mapped data set. A subsequent data processing process is specific to the pseudorandom numbers, and has no obvious relationship with the original private data in terms of form.

Step S103: Obtain a function in a polynomial form through fitting based on the first mapped data set. For example, n pieces of data stored in the first party are fitted to obtain a function f(x)=aₙxⁿ+aₙ₋+ . . . +a₁x+aₒ in a polynomial form with a highest degree of n.

In some example implementations, the polynomial with the highest degree of n can be obtained through fitting by using a least squares method/procedure.

Step S105: Combine coefficients of all terms in the function into a coefficient vector L.

$$L = [ \begin{matrix}{a}_{n} \\ {a}_{n - 1} \\ … \\ {a}_{1} \\ {a}_{0}\end{matrix} ]$$

Step S107: Receive a public key PK from the second party, and perform homomorphic encryption on the coefficient vector L by using the public key PK to obtain an encrypted coefficient vector L_{c}=Enc(L, PK,e)=PK√(vL)+e.

In some example implementations, the second party invokes a key generator KeyGen(80 ) to generate a pair of a private key SK and a public key PK, and performsKeyGen(λ) homomorphic encryption Enc(L, PK, e) on the coefficient vector L based on the public key PK to obtain an encrypted coefficient vector L_{c}.

The above steps are based on that “SK c=vx+e” is satisfied between ciphertext and plaintext that undergo homomorphic encryption based on a vector, where e represents an error vector, v represents a large integer, and c and x respectively represent the corresponding ciphertext and plaintext.

Step S109: Receive a ciphertext input vector X_{ic} from the second party, and obtain a ciphertext result y_{ic}=X_{ic}·L_{c} through computation with reference to the incrypted coefficient vector L_{c}.

In some example implementations, the private key generated by invoking the key generator KeyGen(80 ) can be represented as SK=[I,T]Pₛ, and the generated public key can be represented as

$$PK = {P}_{m} [ \begin{matrix}I - TA \\ A\end{matrix} ] ,$$

where Pₛ and Pₘ are a pair of invertible matrices, Pₛ·Pₘ=I, I represents an identity matrix, both A and T represent random matrices, and λ represents a security parameter.

In some example implementations, the ciphertext input vector is obtained based on following steps: generating random matrices T′ and A′; generating an identity matrix I′; generating a pair of invertible matrices and P′ₛ and P′ₘ; obtaining the ciphertext input vector X_{ic} through computation based on the random matrices T′ and A′, the identity matrix I′, the invertible matrix P′ₘ, and the private key SK of the second party.

Step S111: Send the ciphertext result to the second party, so that the second party obtains a result of unbalanced PSI.

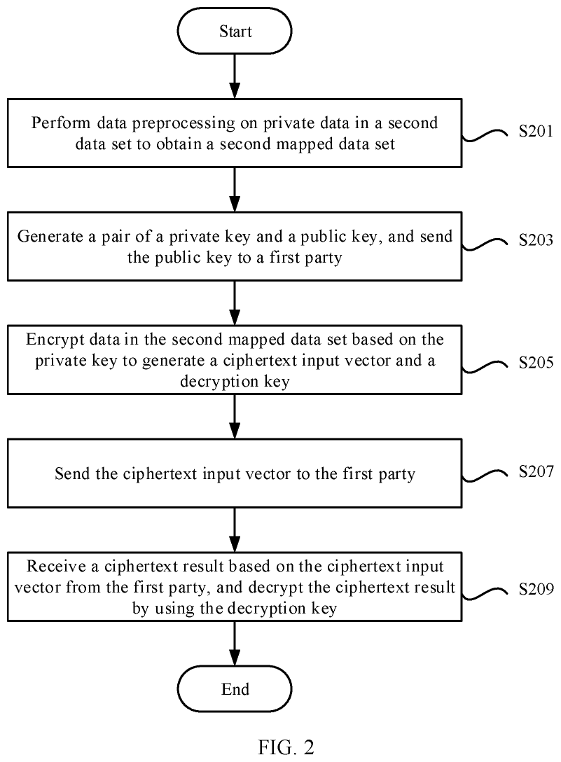

FIG. 2 is an example block diagram illustrating a procedure of a process for unbalanced PSI according to a second implementation of the present application.

Referring to FIG. 2, in this implementation, a first party holds a first data set Y={yₒ₁, y₀₂, . . . , yₒₙ}, a second party holds a second data set X={xₒ₁, . . . , aₒₘ}, and the process for unbalanced PSI is implemented by the second party holding the second data set.

As shown in FIG. 2, the method for unbalanced PSI includes following steps.

Step S201: Perform data preprocessing on private data in the second data set to obtain a second mapped data set.

In some implementations, private data of the first party is a user identifier of a to-be-queried user, and the private data of the second party is a group of user identifiers of a target category.

In some implementations, to improve security of an anonymous query, the private data in the second data set is preprocessed by using OPRF to convert the second data set into the second mapped data set. Correspondingly, the private data in the second data set is converted into pseudorandom numbers in the second mapped data set. A subsequent data processing process is specific to the pseudorandom numbers, and has no obvious relationship with the original private data in terms of form.

Step S203: Generate a pair of a private key and a public key, and send the public key to the first party. In some example implementations, the second party invokes a key generator KeyGen(80 ) to generate a pair of a private key SK and a public key PK. The private key generated by invoking the key generator KeyGen(λ) can be represented as SK=[I, T]Pₛ, and the generated public key can be represented as

$$PK = {P}_{m} [ \begin{matrix}I - TA \\ A\end{matrix} ] ,$$

where Pₛ and Pₘ are a pair of invertible matrices, Pₛ·Pₘ=I, I represents an identity matrix, both A and T represent random matrices, and X, represents a security parameter.

Step S205: Encrypt data in the second mapped data set based on the private key to generate a ciphertext input vector and a decryption key.

In some example implementations, the ciphertext input vector is obtained based on following steps: generating random matrices T′ and S′; generating an identity matrix I′; generating a pair of invertible matrices Pₛ and P′ₘ; and obtaining the ciphertext input vector X_{ic} through computation based on the random matrices T′ and A′, the identity matrix I′, the invertible matrix P′ₘ, and the private key SK of the second party.

In some example implementation, the decryption key is generated based on following steps: generating random matrices and T′ and A′; generating an identity matrixI′; generating a pair of invertible matrices P′ₛ and P′ₘ; and generating the decryption key SK′=[I′, T′]·P′ₛ through computation based on the random matrix T′, the identity matrix I′, and the invertible matrix P′ₛ.

Step S207: Send the ciphertext input vector to the first party.

Step S209: Receive a ciphertext result based on the ciphertext input vector from the first party, and decrypt the ciphertext result by using the decryption key to obtain a result of unbalanced PSI.

In some example implementations, the ciphertext result y_{ic} is obtained through computation based on the ciphertext input vector X_{ic} and the encrypted coefficient vector L_{c}.

y_{ic}=X_{ic}·L_{c}

It can be appreciated from the above mathematical expression of the ciphertext result that, the ciphertext input vector X_{ic} is an encrypted data matrix, and the encrypted coefficient vector L_{c}is also an encrypted data matrix. When the ciphertext result is computed, no polynomial with a degree up to n appears. Therefore, in the present application, computation of a polynomial with any number of degrees can be converted into one linear transformation operation, which not only ensures ciphertext computing efficiency and security, but also improves retrieval query efficiency.

For the unbalanced PSI, the first party performs data preprocessing based on OPRF, and establishes an interpolation polynomial f(x)=(x−y₁)(x−y₂( . . . (x−yₙ) based on the preprocessed first mapped data set. Data xᵢ of the second party used as query data is used as an input of the interpolation polynomial to compute f(xᵢ). If f(xᵢ) is equal to 0, certain data y equal to xᵢ necessarily exists in {y₁, y₂, . . . yₙ}, that is, y and xᵢ are intersection data in the first data set held by the first party and the second data set held by the second party.

In some example implementations, when receiving the ciphertext result Y_{ic} based on the ciphertext input vector x_{ic} from the first party, the second party obtains the result of the unbalanced PSI through computation by using the decryption key SK′.

$$y = \frac{{SK}^{′} \cdot {y}_{ic}}{v}$$

If y=9, the pseudorandom number xᵢ in the second mapped data set is one piece of intersection data, and correspondingly, the private data xₒᵢ that is in the second data set and that is mutually mapped to the pseudorandom number xᵢ is the intersection data.

If y≠0, the pseudorandom number xᵢ in the second mapped data set is not one piece of intersection data, and correspondingly, the private data xₒᵢ that is in the second data set and that is mutually mapped to the pseudorandom number xᵢ is not the intersection data.

In some implementation, the method in the present application can also be used to implement batch query processing of a user, to be specific, a same user determines, at one time, whether a plurality of pieces of data (x₁, x₂, . . . , xₘ) are intersection data. In this case, a result of determining whether the plurality of pieces of data are the intersection data can be obtained based on following steps:

computing a vector matrix X in plaintext based on degree information [n, n−1, . . . , 1, 0] of the function f(x) sent by the first party, where

$$X = [ \begin{matrix}{x}_{1}^{n} , {x}_{1}^{n - 1} , … , {x}_{1}^{1} , 1 \\ {x}_{2}^{n} , {x}_{2}^{n - 1} , … , {x}_{2}^{1} , 1 \\ … \\ {x}_{m}^{n} , {x}_{m}^{n - 1} , … , {x}_{m}^{1} , 1\end{matrix} ] ;$$

randomly generating an invertible matrix pair P′ₛ·P′ₘ=I;

randomly generating matrices T′ and S′;

generating the decryption key SK′−[I′, T′]·P′ₛ;

generating a ciphertext query vector

$${X}_{c} = {P}_{m}^{′} ( \begin{matrix}X \cdot {SK}_{u} - {T}^{′} {A}^{′} \\ {A}^{′}\end{matrix} ) ;$$

and

sending the ciphertext query vector X_{c} to the first party for batch query processing.

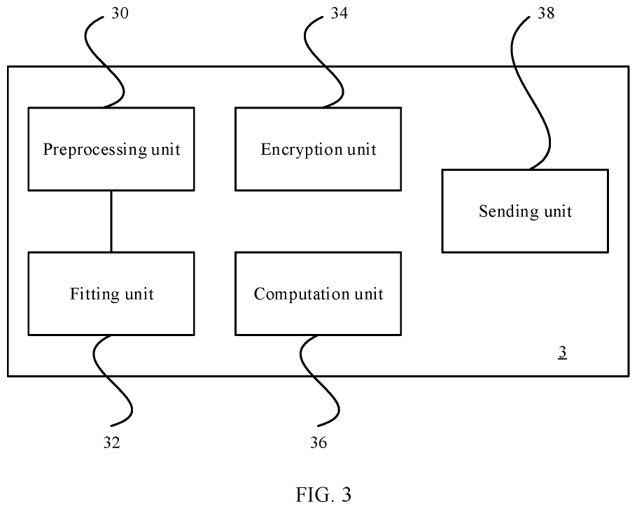

FIG. 3 is an example schematic diagram illustrating a system architecture of an apparatus for unbalanced PSI according to a third implementation of the present application.

Referring to FIG. 3, in this implementation, a first party holds a first data set Y={yₒ₁, Yₒ₂, . . . , yₒₙ}, and a second party holds a second data set X={xₒ₁, . . . , xₒₘ}. The apparatus for unbalanced PSI is disposed in the first party.

As shown in FIG. 3, the apparatus includes a preprocessing unit 30, a fitting unit 32, an encryption unit 34, a computation unit 36, and a sending unit 38.

The preprocessing unit 30 is configured to perform data preprocessing on private data in the first data set to obtain a first mapped data set.

In some implementations, the private data of the first party is a user identifier of a to-be-queried user, and private data of the second party is a group of user identifiers of a target category.

In some implementations, to improve security of an anonymous query, the private data in the first data set is preprocessed by using OPRF to covert the first data set into the first mapped data set. Correspondingly, the private data in the first data set is converted into pseudorandom numbers in the first mapped data set. A subsequent data processing process is specific to the pseudorandom numbers, and has no obvious relationship with the original private data in terms of form.

The fitting unit 32 is configured to: obtain a function in a polynomial form through fitting based on the first mapped data set, and combine coefficients of all terms in the function into a coefficient vector. For example, the fitting unit 32 fits n pieces of data stored in the first party to obtain a function f(x)=aₙxⁿ+aₙ₋₁xⁿ⁻¹+ . . . +a₁x+a₀ in a polynomial form with a highest degree of n.

In some example implementations, the polynomial with the highest degree of n can be obtained through fitting by using a least squares method/procedure.

The encryption unit 34 is configured to: receive a public key PK from the second party, and perform homomorphic encryption on the coefficient vector L by using the public key PK to obtain an encrypted coefficient vector L_{c}=Enc(L, PK, e)=PL·(vL)+e.

In some example implementations, the second party invokes a key generator KeyGen(80 ) to generate a pair of a private key SK and a public key PK, and performs homomorphic encryption Enc(L, PK, e) on the coefficient vector L based on the public key PK to obtain an encrypted coefficient vector L_{c}.

The above steps are based on that “SK c=vx+e” is satisfied between ciphertext and plaintext that undergo homomorphic encryption based on a vector, where e represents an error vector, v represents a large integer, and c and x respectively represent the corresponding ciphertext and plaintext.

The computation unit 36 is configured to: receive a ciphertext input vector X_{ic} from the second party, and obtain a ciphertext result y_{ic}=X_{ic}·L_{c} through computation with reference to the encrypted coefficient vector L_{c}.

In some example implementations, the private key generated by invoking the key generator KeyGen(λ) can be represented as SK=[I, T]Pₛ, and the generated pubic key can be represented as

$$PK = {P}_{m} [ \begin{matrix}I - TA \\ A\end{matrix} ] ,$$

where Pₛ and Pₘ are a pair of invertible matrices, Pₛ·Pₘ=I, I represents an identity matrix, both A and T represent random matrices, and λ represents a security parameter.

In some example implementation, the ciphertext input vector is obtained based on following steps: generating random matrices T′ and A′; generating an identity matrix I′; generating a pair of invertible matrices P′ₛ and P′ₘ; and obtaining the ciphertext input vector X_{ic} through computation based on the random matrices T′ and A′, the identity matrix I′, the invertible matrix P′ₘ, and the private key SK of the second party.

The sending unit 38 is configured to send the ciphertext result to the second party, so that the second party obtains a result of unbalanced PSI.

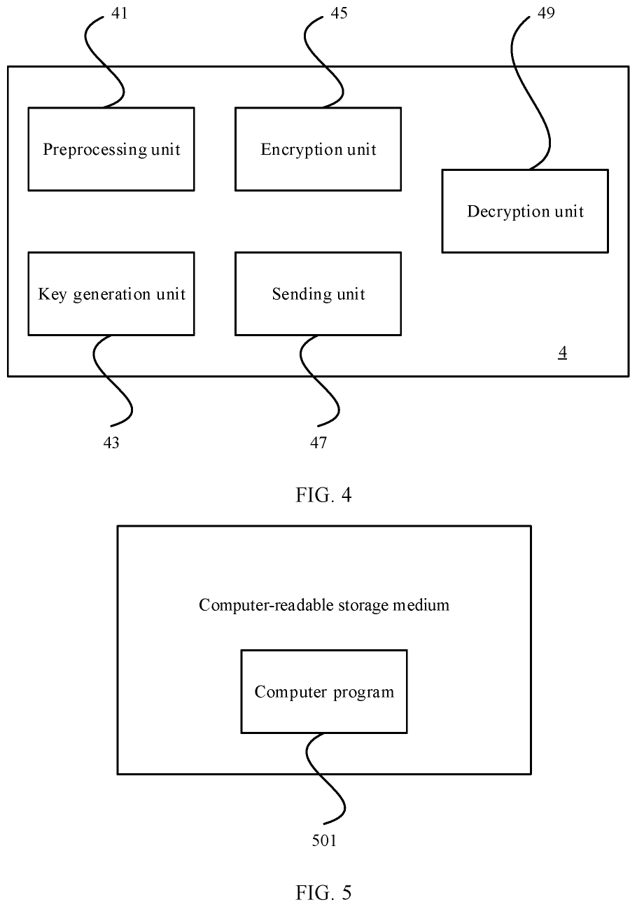

FIG. 4 is an example schematic diagram illustrating a system architecture of an apparatus for unbalanced PSI according to a fourth implementation of the present application.

Referring to FIG. 4, in this implementation, a first party holds a first data set Y={yₒ₁, Yₒ₂, . . . , yₒₙ}, and a second party holds a second data set X={xₒ₁, . . . , xₒₘ}. The apparatus for unbalanced PSI is disposed in the second party.

As shown in FIG. 4, the apparatus includes a preprocessing unit 41, a key generation unit 43, an encryption unit 45, a sending unit 47, and a decryption unit 49.

The preprocessing unit 41 is configured to perform data preprocessing on private data in the second data set to obtain a second mapped data set.

In some implementations, private data of the first party is a user identifier of a to-be-queried user, and the private data of the second party is a group of user identifiers of a target category.

In some implementations, to improve security of an anonymous query, the private data in the second data set is preprocessed by using OPRF to convert the second data set into the second mapped data set. Correspondingly, the private data in the second data set is converted into pseudorandom numbers in the second mapped data set. A subsequent data processing process is specific to the pseudorandom numbers, and has no obvious relationship with the original private data in terms of form.

The key generation unit 43 is configured to: generate a pair of a private key and a public key based on a homomorphic encryption algorithm, and send the public key to the first party.

In some example implementations, the second party invokes a key generator KeyGen(λ) to generate a pair of a private key SK and a public key PK. The private key generated by invoking the key generator KeyGen(λ) can be represented as SK=[I, T]|Pₛ, and the generated public key can be represented as

$$PK = {P}_{m} [ \begin{matrix}I - TA \\ A\end{matrix} ] ,$$

where Pₛ and Pₘ are a pair of invertible matrices, Pₛ·Pₘ=I, I represents an identity matrix, both A and T represent random matrices, and λ represents a security parameter.

The encryption unit 45 is configured to encrypt data in the second mapped data set based on the private key to generate a ciphertext input vector and a decryption key.

In some example implementations, the ciphertext input vector is obtained based on following steps: generating random matrices T′ and A′; generating an identity matrix I′; generating a pair of invertible matrices P′ₛ and P′ₘ; and obtaining the ciphertext input vector X_{ic} through computation based on the random matrices T′ and A′, the identity matrix I′, the invertible matrix P′ₘ, and the private key SK of the second party.

In some example implementations, the decryption key is generated based on following steps: generating random matrices T′ and A′; generating an identity matrix I′; generating a pair of invertible matrices P′ₓ and P′ₘ; and generating the decryption key SK′=[I′, T′]·P′ₛ through computation based on the random matrix T′, the identity matrixI′, and the invertible matrix P′ₛ.

The sending unit 47 is configured to send the ciphertext input vector to the first party.

The decryption unit 49 is configured to: receive a ciphertext result based on the ciphertext input vector from the first party, and decrypt the ciphertext result by using the decryption key to obtain a result of unbalanced PSI.

In some example implementations, the ciphertext result y_{ic} is obtained through computation based on the ciphertext input vector X_{ic} and the encrypted coefficient vector L_{c}.

y_{ic}=X_{ic}·L_{c}

It can be appreciated from the above mathematical expression of the ciphertext result that, the ciphertext input vector X_{ic} is an encrypted data matrix, and the encrypted coefficient vector L_{c} is also an encrypted data matrix. When the ciphertext result is computed, no polynomial with a degree up to n appears. Therefore, in the present application, computation of a polynomial with any number of degrees can be converted into one linear transformation operation, which not only ensures ciphertext computing efficiency and security, but also improves retrieval query efficiency.

According to the principle of the unbalanced PSI, the first party performs data preprocessing based on OPRF, and establishes an interpolation polynomial f(x)=(x−y₁)(x−y₂ . . . (x−yₙ) based on the preprocessed first mapped data set. Data xᵢ of the second party used as query data is used as an input of the interpolation polynomial to compute f(xᵢ). If f(xᵢ) is equal to 0, certain data y equal to xᵢ necessarily exists in {y₁, y₂, . . . , yₙ}, that is, y and xᵢ are intersection data in the first data set held by the first party and the second data set held by the second party.

In some example implementations, when receiving the ciphertext result based on the ciphertext input vector X_{ic} from the first party, the second party obtains the result of the unbalanced PSI through computation by using the decryption key SK′.

$$y = \frac{{SK}^{′} \cdot {y}_{ic}}{v}$$

If y=0, the pseudorandom number xᵢ in the second mapped data set is one

piece of intersection data, and correspondingly, the private data xₒᵢ that is in the second data set and that is mutually mapped to the pseudorandom number is the intersection data.

If y≠0, the pseudorandom number xᵢ in the second mapped data set is not one piece of intersection data, and correspondingly, the private data that is in the second data set and that is mutually mapped to the pseudorandom number Xₒᵢ is not the intersection data.

To illustrate some technical effects of the method and the apparatus for unbalanced PSI in the present application, a decryption process is expanded herein as:

$${SK}^{′} \cdot {y}_{ic} = {SK}^{′} \cdot {X}_{ic} \cdot {L}_{c} = [ {I}^{′} , {T}^{′} ] \cdot {P}_{s}^{′} \cdot {P}_{m}^{′} \cdot [ \begin{matrix}{X}_{i} \cdot SK - {T}^{′} {A}^{′} \\ {A}^{′}\end{matrix} ] \cdot PK \cdot ( vL ) + {e}^{′} = {X}_{i} \cdot SK \cdot PK \cdot ( vL ) + {e}^{′} = v ( {X}_{i} \cdot L ) + {e}^{′} = v ( [ {x}_{i}^{n} , {x}_{i}^{n - 1} , {x}_{i} … , {x}_{i} , 1 ] \cdot [ \begin{matrix}{a}_{n} \\ {a}_{n - 1} \\ … \\ {a}_{1} \\ {a}_{0}\end{matrix} ] ) \text{} + {e}^{′} = v ( {a}_{n} {x}_{i}^{n} + {a}_{n - 1} {x}_{i}^{n - 1} + … {a}_{1} {x}_{i} + {a}_{0} ) + {e}^{′}$$

where e′ in the above formula represents small noise, and

$$\frac{{e}^{′}}{v} \approx 0.$$

The above result is divided by a big integer v to obtain aₙxᵢⁿ+zₙ−1xᵢⁿ⁻¹+ . . . a₁xᵢ+a₀, that is, a final decryption result y. Therefore, it can be appreciated that the decryption result is equal to a computation result of a function in a polynomial form in plaintext, and is also equal to a query result.

The same method is used to verify technical effects of determining, by a same user at one time, whether a plurality of pieces of data are intersection data. A final decryption form is:

$$v ( [ \begin{matrix}{x}_{1}^{n} , {x}_{1}^{n - 1} , … , {x}_{1}^{1} , 1 \\ {x}_{2}^{n} , {x}_{2}^{n - 1} , … , {x}_{2}^{1} , 1 \\ … \\ {x}_{m}^{n} , {x}_{m}^{n - 1} , … , {x}_{m}^{1} , 1\end{matrix} ] \cdot [ \begin{matrix}{a}^{n} \\ {a}^{n - 1} \\ … \\ a \\ {a}_{0}\end{matrix} ] )$$

A result is equal to

$$[ \begin{matrix}{y}_{1} = f ( {x}_{1} ) \\ {y}_{2} = f ( {x}_{2} ) \\ … \\ {y}_{m} = f ( {x}_{m} )\end{matrix} ] .$$

Therefore, it can be appreciated that when batch query processing is performed, the decryption result is also equal to a computation result of a function in a polynomial form in plaintext, and is also equal to a query result. This verification also indicates that batch query processing is correctly completed by using the method and the apparatus in the present application.

FIG. 5 is an example diagram illustrating a structure of a computer-readable storage medium corresponding to a method for unbalanced PSI according to another implementation of the present application.

Referring to FIG. 5, this implementation further provides a computer-readable storage medium. The computer-readable storage medium includes one or more computer programs 501. These computer programs 501 store instructions. When the instructions are run on a processor, the above method for unbalanced PSI is performed. For example, the computer instructions can include computer program code, and the computer program code can be in a source code form, an object code form, an executable file, or some intermediate forms.

The processor can include one or more processing units. For example, the processor can include one or more of an application processor (AP), a modem processor, a graphics processing unit (GPU), an image signal processor (ISP), a controller, a memory, a video codec, a digital signal processor (DSP), a baseband processor, and a neural-network processing unit (NPU). Different processing units can be independent components, or can be integrated into one or more processors.

The computer-readable medium shown in the present invention can be a computer-readable signal medium, a computer-readable storage medium, or any combination of the two. For example, the computer-readable storage medium can be, but is not limited to, an electrical, magnetic, optical, electromagnetic, infrared, or semiconductor system, apparatus, or component, or any combination thereof. More specific examples of the computer-readable storage medium can include but are not limited to: an electrical connection having one or more wires, a portable computer disk, a hard disk, a random access memory (RAM), a read-only memory (ROM), an erasable programmable read-only memory (EPROM or a flash memory), an optical fiber, a portable compact disc read-only memory (CD-ROM), an optical storage component, a magnetic storage component, or any appropriate combination thereof. In the present invention, the computer-readable storage medium can be any tangible medium that includes or stores a program, and the program can be used by or in combination with an instruction execution system, apparatus, or component. In the present invention, the computer-readable signal medium can include a data signal propagated in a baseband or as a part of a carrier, and includes computer-readable program code. The propagated data signal can be in a plurality of forms, including but not limited to an electromagnetic signal, an optical signal, or any appropriate combination thereof. The computer-readable signal medium can alternatively be any computer-readable medium other than the computer-readable storage medium, and the computer-readable medium can send, propagate, or transmit a program used by or in combination with an instruction execution system, apparatus, or component. The program code included in the computer-readable medium can be transmitted by using any appropriate medium, including but not limited to wireless, a cable, an optical cable, RF, or any appropriate combination thereof.

It can be appreciated from the above that, in the implementations of the present specification, the first party holding the first data set can obtain, from the second party holding the second data set, only the ciphertext input vector obtained through homomorphic encryption, and the first party cannot infer any data included in the second data set by using the ciphertext input vector. The first party sends the ciphertext result to the second party, and the ciphertext result is also obtained by the first party through linear transformation computation by using two encryption matrices. The second party decrypts the ciphertext result by using the decryption key, and can only determine, based on the decrypted ciphertext result, whether the private data of the first party belongs to the second data set, and cannot inversely deduce and determine a specific location of to-be-queried data in the data set, so that a security requirement of an anonymous query can be satisfied. Compared with the existing technologies, in the method for unbalanced PSI in this solution, a complex computation process of PSI is converted into a simple matrix transformation operation, which not only ensures ciphertext computing efficiency and retrieval efficiency, but also can implement many advantages such as batch processing and compatibility.

Example implementations of the present application are described above with reference to the accompanying drawings. However, a person of ordinary skill in the art can understand that various changes and replacements can be made to the example implementations of the present application without departing from the spirit and scope of the present application. These changes and replacements all fall within the scope defined by the claims of the present application.

What is claimed is:

1. A method for unbalanced private set intersection (PSI), a first party having a first data set, a second party having a second data set, the method comprising:
performing data preprocessing on private data in the first data set to obtain a first mapped data set;
obtaining a polynomial function through fitting based on the first mapped data set;
combining coefficients of terms in the polynomial function into a coefficient vector;
receiving a public key from the second party;
performing homomorphic encryption on the coefficient vector by using the public key to obtain an encrypted coefficient vector;
receiving a ciphertext input vector from the second party;
obtaining a ciphertext result through computation based on the ciphertext input vector and the encrypted coefficient vector; and
sending the ciphertext result to the second party for the second party to obtain a result of unbalanced PSI.

2. The method according to claim 1, wherein the performing data preprocessing on the private data in the first data set includes performing data preprocessing by using an oblivious pseudorandom function (OPRF), and
wherein data in the first mapped data set are pseudorandom numbers.

3. The method according to claim 1, wherein the private data of the first party is a user identifier of a to-be-queried user, and private data in the second data set of the second party is a group of user identifiers of a target category.

4. The method according to claim 1, comprising obtaining, by the second party, ciphertext input vector, the obtaining including:
generating a random matrix;
generating an identity matrix;
generating an invertible matrix pair; and
obtaining the ciphertext input vector through computation based on the random matrix, the identity matrix, the invertible matrix pair, and a private key of the second party.

5. The method according to claim 1, wherein the polynomial function is obtained through fitting by using a least squares procedure.

6. A method for unbalanced private set intersection (PSI), a first party holding a first data set, a second party holding a second data set, the method comprising:
performing data preprocessing on private data in the second data set to obtain a second mapped data set;
generating a pair of a private key and a public key;
sending the public key to the first party;
encrypting data in the second mapped data set based on the private key to generate a ciphertext input vector and a decryption key;
sending the ciphertext input vector to the first party; and
receiving a ciphertext result that is generated based on the ciphertext input vector from the first party; and
decrypting the ciphertext result by using the decryption key to obtain a result of unbalanced PSI.

7. The method according to claim 6, wherein the performing data preprocessing on the private data in the second data set includes:
performing data preprocessing by using an oblivious pseudorandom function (OPRF), and wherein data in the second mapped data set are pseudorandom numbers.

8. The method according to claim 6, wherein the generating the ciphertext input vector includes:
generating a random matrix;
generating an identity matrix;
generating an invertible matrix pair; and
obtaining the ciphertext input vector through computation based on the private key, the random matrix, the identity matrix, and the invertible matrix pair.

9. The method according to claim 6, wherein the generating the decryption includes:
generating a random matrix;
generating an identity matrix;
generating an invertible matrix pair; and
generating the decryption key through computation based on the random matrix, the identity matrix, and the invertible matrix pair.

10. The method according to claim 6, wherein the obtaining the result of unbalanced PSI includes:
in response to a result of the unbalanced PSI obtained through the decrypting is 0, determining that private data of the first party is intersection data; and
in response to the result of the unbalanced PSI obtained through the decrypting is not 0, determining that the private data of the first party is not intersection data.

11. The method according to claim 6, wherein private data in the first data set of the first party is a user identifier of a to-be-queried user, and the private data of the second party is a group of user identifiers of a target category.

12. A computer system comprising one or more storage device and one or more processors, the one or more storage devices, individually or collectively, having executable instructions stored thereon, the executable instructions, when executed by the one or more processors, enabling the one or more processors to implement acts including:
performing data preprocessing on private data in a first data set of a first party to obtain a first mapped data set;
obtaining a polynomial function through fitting based on the first mapped data set;
combining coefficients of terms in the polynomial function into a coefficient vector;
receiving a public key from a second party;
performing homomorphic encryption on the coefficient vector by using the public key to obtain an encrypted coefficient vector;
receiving a ciphertext input vector from the second party;
obtaining a ciphertext result through computation based on the ciphertext input vector and the encrypted coefficient vector; and
sending the ciphertext result to the second party for the second party to obtain a result of unbalanced PSI.

13. The computer system according to claim 12, wherein the performing data preprocessing on the private data in the first data set includes performing data preprocessing by using an oblivious pseudorandom function (OPRF), and
wherein data in the first mapped data set are pseudorandom numbers.

14. The computer system according to claim 12, wherein the acts include obtaining, by the second party, ciphertext input vector, the obtaining including:
generating a random matrix;
generating an identity matrix;
generating an invertible matrix pair; and
obtaining the ciphertext input vector through computation based on the random matrix, the identity matrix, the invertible matrix pair, and a private key of the second party.

15. The computer system according to claim 12, wherein the polynomial function is obtained through fitting by using a least squares procedure.

16. A computer system comprising one or more storage device and one or more processors, the one or more storage devices, individually or collectively, having executable instructions stored thereon, the executable instructions, when executed by the one or more processors, enabling the one or more processors to implement acts including:
performing data preprocessing on private data in a first data set of a first party to obtain a first mapped data set;
generating a pair of a private key and a public key;
sending the public key to a second party;
encrypting data in the first mapped data set based on the private key to generate a ciphertext input vector and a decryption key;
sending the ciphertext input vector to the second party; and
receiving a ciphertext result that is generated based on the ciphertext input vector from the second party; and
decrypting the ciphertext result by using the decryption key to obtain a result of unbalanced PSI.

17. The computer system according to claim 16, wherein the performing data preprocessing on the private data in the first data set includes:
performing data preprocessing by using an oblivious pseudorandom function (OPRF), and wherein data in the first mapped data set are pseudorandom numbers.

18. The computer system according to claim 16, wherein the generating the ciphertext input vector includes:
generating a random matrix;
generating an identity matrix;
generating an invertible matrix pair; and
obtaining the ciphertext input vector through computation based on the private key, the random matrix, the identity matrix, and the invertible matrix pair.

19. The computer system according to claim 16, wherein the generating the decryption includes:
generating a random matrix;
generating an identity matrix;
generating an invertible matrix pair; and
generating the decryption key through computation based on the random matrix, the identity matrix, and the invertible matrix pair.

20. The computer system according to claim 6, wherein the obtaining the result of unbalanced PSI includes:
in response to a result of the unbalanced PSI obtained through the decrypting is 0, determining that private data of the second party is intersection data; and
in response to the result of the unbalanced PSI obtained through the decrypting is not 0, determining that the private data of the second party is not intersection data.
